(19) United States
(12) Patent Application Publication
(10) Pub. No.: US 2016/0117335 A1
(43) Pub. Date: Apr. 28, 2016

(54) SYSTEMS AND METHODS FOR ARCHIVING MEDIA ASSETS

(71) Applicant: Fictive Kin LLC, Brooklyn, NY (US)

(72) Inventors: Sean Coates, Dorval (CA); Evan Kurtis Haas, Portland, OR (US)

(21) Appl. No.: 14/989,541

(22) Filed: Jan. 6, 2016

Related U.S. Application Data
(62) Division of application No. 13/267,652, filed on Oct. 6, 2011, now abandoned.
(60) Provisional application No. 61/344,829, filed on Oct. 19, 2010.

(51) Int. Cl. G06F 17/30; H04L 29/08

(52) U.S. Cl. CPC G06F 17/30073; H04L 67/06

(57) ABSTRACT

System and method for archiving media assets associated with a structured document. A first user input is used to identify one or more media assets, a second user input is used to indicate that the one or more media assets should be archived, and metadata associated with the one or more media assets is obtained from the structured document and provided to a server. The server uses the metadata to obtain and archive the media assets.

This application claims priority to U.S. provisional application 61/344,829, filed Oct. 19, 2010, incorporated herein by reference in its entirety.

### BACKGROUND

1. Field of the Invention

The present invention relates to systems and methods for archiving media assets. More particularly, aspects of the present invention relate to systems and methods for archiving media assets associated with structured documents.

2. Description of the Background

The Internet, including the World Wide Web, provides users with an unprecedented amount of information and media. Many users of the Internet view tens or even hundreds of web pages daily and discover content that they may desire to access at a later time (e.g., to prepare compilations, critiques, commentary, or other analysis) or to share with others based on common interests. One problem that is frequently encountered is that, as time passes, a user may be no longer able to locate the content that was previously identified. For example, a user may forget how to access a media asset. Furthermore, even when a user has maintained a record how to access a media asset (often in the form of a Uniform Resource Locator or “URL”), the provider of that media asset may have moved the asset to a new location (e.g., to a location that is only accessible by a new, different URL), rendering the user's records obsolete. Thus users can waste much time re-locating content that was previously identified as noteworthy.

One approach to solving this problem is for the user to store on the user's computer any interesting content whenever a user encounters it. However, this approach has several substantial drawbacks. Remotely accessing media assets stored on a user's workstation is typically beyond the skill level of ordinary users; thus, a user will typically be unable to access the stored media assets from any other computer workstation or portable computer terminal (e.g., a user will typically be unable to access a stored media asset from cellular telephone or a portable digital assistant). Furthermore, persons other than the user will typically be unable to access media assets that are stored on the user's computer, making it difficult for the user to share the media assets. Still further, typical web browsing software disregards much of the metadata information associated with downloaded files, so the media asset will likely be stripped of most contextual information. Thus a user may need to recreate metadata information multiple times if the stored media asset is utilized multiple times (e.g., if the stored media is posted to a web log, stored in a user's personal archive, etc.).

What is desired is a way for a user to easily archive and share content from the Internet, and in particular, the World Wide Web.

### BRIEF SUMMARY

In one aspect, the present invention provides a method for archiving a media asset (e.g., text, an image, video, audio, or other media files, etc.) associated with a structured document (i.e., a document that includes data or metadata indicating one or more organizational or semantic relations between or among portions of the document, such as a HyperText Markup Language (“HTML”) page or other web page). In some embodiments, the method includes steps of: detecting a first user input event associated with the structured document; identifying a media asset associated with the structured document based on the first user input event; obtaining from the structured document metadata that is associated with the identified media asset; detecting a second user input event; and in response to detecting the second user input event, transmitting the metadata to a remote server.

In one aspect, the present invention provides a method for archiving a media asset. In some embodiments, the method includes steps of: transmitting from a first security domain to a remote server metadata associated with the media asset; receiving at the first security domain from the remote server an indication that the remote server did not archive the media asset; transmitting a request from the first security domain to a second security domain; in response to receiving said request at the second security domain, obtaining the media asset at the second security domain; at the second security domain, serializing the media asset; transmitting the serialized media asset from the second security domain to the first security domain; and transmitting the serialized media asset from the second security domain to the remote server.

In one aspect, the present invention provides a system for archiving a media asset associated with a structured document. In some embodiments, the system includes user terminal and an archive server. In some embodiments, the user terminal is configured to: detect a first user input event associated with the structured document, identify a media asset associated with the structured document based on the first user input event, obtain from the structured document metadata that is associated with the identified media asset, detect a second user input event, and transmit the metadata to a remote server in response to detecting the second user input event. In some embodiments, the archive server is configured to receive the metadata from the user workstation; obtain the media asset data from a remote server; store the media asset data in a data store; and index the asset data in the data store based on the metadata.

In one aspect, the present invention provides a method for archiving a media asset associated with a structured document. In some embodiments, the method includes steps of: providing via a digital communication network computer executable software instructions, wherein the execution of the provided software instructions will cause a computer to detect a first user input event associated with a structured document; identify a media asset associated with the structured document based on the first user input event; obtain from the structured document metadata that is associated with the identified media asset; detect a second user input event; and in response to detecting the second user input event, transmit the metadata to a remote server.

In one aspect, the present invention provides a computer readable medium storing computer executable instructions. In some embodiments, the computer executable instructions include instructions for: detecting a first user input event associated with the structured document; identifying a media asset associated with the structured document based on the first user input event; obtaining from the structured document metadata that is associated with the identified media asset; detecting a second user input event; and in response to detecting the second user input event, transmitting the metadata to a remote server.

The above and other aspects of the present invention, as well as the structure and application of various embodiments of the present invention, are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar element.

A more complete appreciation of the invention and the attendant advantages thereof will be readily obtained as the same becomes better understood by reference to the following detailed description when considered with the accompanying drawings wherein:

FIG. 1 is a block diagram of a computer network according to some aspects of the present invention.

FIG. 2 is a block diagram of a user terminal according to some aspects of the present invention.

FIG. 3 is a user interface according to some aspects of the present invention.

FIG. 4 is a flow chart illustrating a process for archiving media assets according to some aspects of the present invention.

FIG. 5 is a flow chart illustrating a process for archiving media assets according to some aspects of the present invention.

FIG. 6 is a flow chart illustrating a process for archiving media assets according to some aspects of the present invention.

### DETAILED DESCRIPTION OF PREFERRED EMBODIMENTS

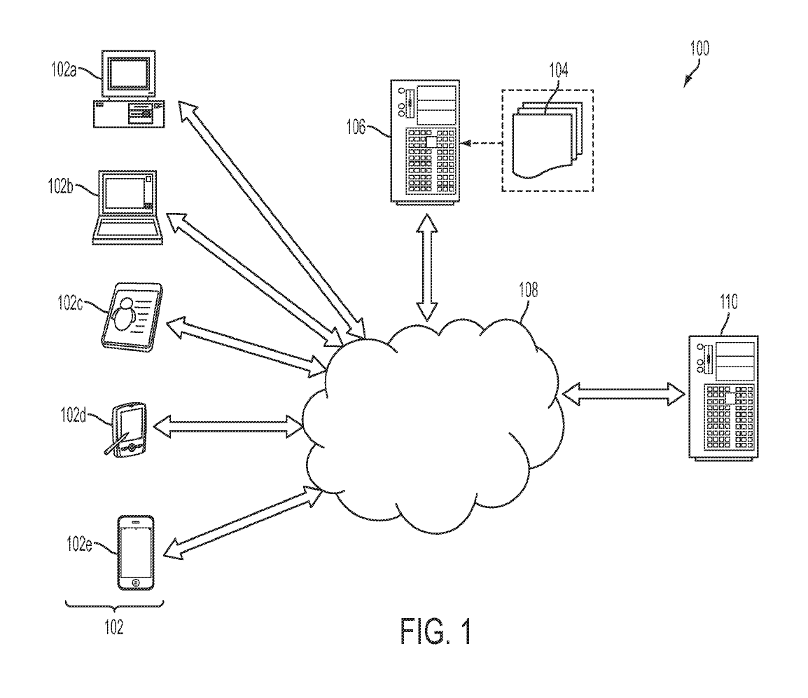

FIG. 1 is a block diagram of a system 100 according to some aspects of the present invention. As illustrated in FIG. 1, one or more user terminals 102 (e.g., one or more desktop computers 102a, laptop computers 102b, tablet computers 102c, personal digital assistants (“PDAs”) 102d, smart phones 102e, or any other device capable of displaying structured documents etc.) can access resources 104 (e.g., digital data files or media files, etc.) stored on one or more server computers 106 via an electronic communication network 108 (e.g., the Internet, a cellular data network, etc.). For example, a user terminal 102 can transmit to a specified server 106 over the network 108 a request for a resource 104 stored on that server 106. If the request is valid (e.g., the requested resource 104 is accessible by the specified server 106 and the user terminal 102 is authorized to access the requested resource), then the server 106 can transmit to the workstation 102 over the network 108 the requested resource 104.

In some embodiments of the present invention, the system 100 further includes an archive computer 110 that is coupled to the electronic communication network 108. The archive computer 110 can request resources 104 from the server computers 106, and can receive resources 104 or other data from the user terminals 102.

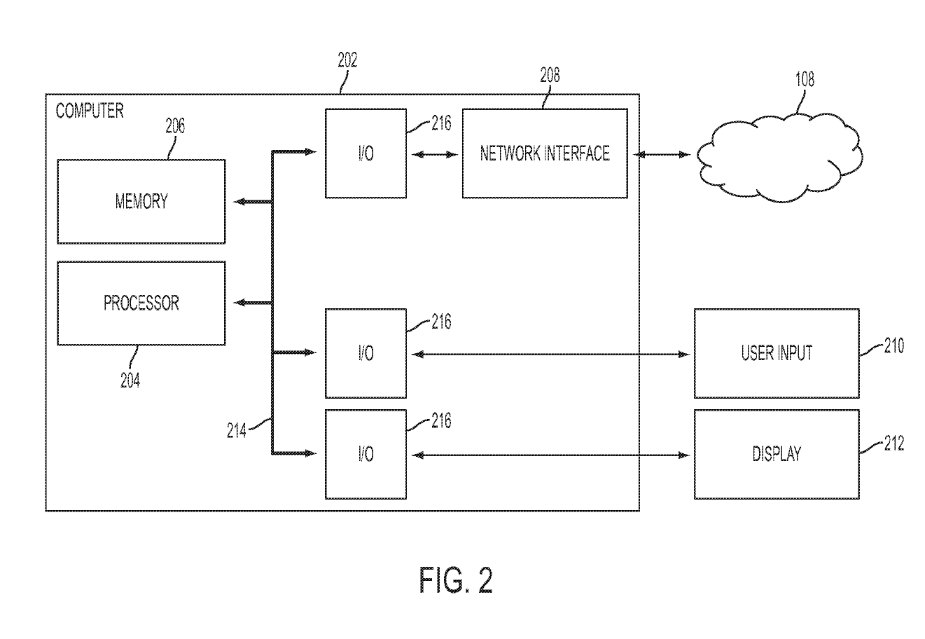

FIG. 2 is a block diagram illustrating a digital computer 202 (e.g., a user terminal 102, server 106, or archive computer 110) according to some aspects of the present invention. In some embodiments, the computer 202 contains one or more processors 204, an computer readable memory 206, a network interface 208, a user input interface 210, and a display 212. The processors 204 can include, for example, one or more of: an application specific integrated circuit (“ASIC”), a field-programmable gate array (“FPGA”), a digital signal processor (“DSP”), an assembly of discrete logical elements (e.g., NAND gates, XOR gates, etc.), or a general purpose microprocessor configured to execute software instructions stored in a computer readable memory (e.g., software instructions stored in the computer readable memory 206). The computer readable memory 206 can include, for example, an electronic random access memory (“RAM”), an electronically erasable and programmable read only memory (“EEPROM”), a magnetic storage medium (e.g., a magnetic hard drive or tape drive), a flash memory, or any other computer readable medium or other means for storing computer executable instructions known to those having skill in the art. In some embodiments, information is transferred between the processor 204 and the computer readable memory 206 using an electronic data bus 214. The data bus 214 can also be connected to one or more input-output (I/O″) units 216. In some embodiments, the units 216 are coupled to the network interface 208, the user input interface 210, and the display 212. The network interface 208 (e.g., an Ethernet interface, an 802.11 wireless networking interface, cellular modem, etc.) may be coupled to the electronic communication network 108 for transmitting and receiving data. The user input interface 210 can include, for example, one or more input devices such as a keyboard, a mouse, a touchscreen, etc. The display 212 can include, for example, a cathode ray tube (“CRT”) display, a liquid crystal display (“LCD”), an organic light emitting diode (“OLED”) display, etc.

In some embodiments the user terminal 102, server 106, or archive computer 110 may omit one or more of the above components; alternately, in some embodiments the user terminal 102, server 106, or archive computer 110 may include one or more additional elements. As will be understood by those having skill in the art, aspects of the present invention can be implemented using a broad array of commercially available computer hardware and software.

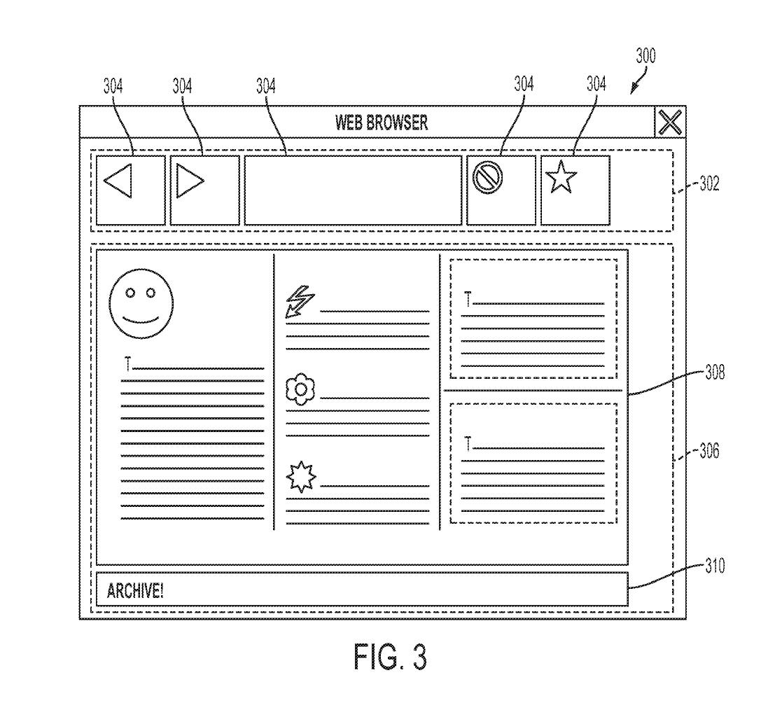

FIG. 3 illustrates a non-limiting example of a user interface 300 for displaying structured documents according to some aspects of the present invention. In some non-limiting embodiments, the user interface 300 is provided by a web browser or other computer software executing in whole or partially on the user terminal 102 (e.g., software stored in the computer readable memory 206 and executing via the processor 204) and configured to display structured documents on the display 212. As illustrated in FIG. 3, the user interface 300 can include one or more user control areas 302 that display user controls 304 for interacting with the user interface 300. The user interface 300 can also include a document display area 306 that displays one or more structured documents 308. In some non-limiting embodiments, the structured documents 308 can include a HyperText Markup Language (“HTML”) document, an eXtensible HyperText Markup Language (“XHTML”) document, or other types of structured documents as will be understood by those having skill in the art. The structured document 308 can include one or more associated media assets (e.g., text, images, hyperlinks, audio, or video content, etc.) that are stored as resources on one or more of the servers 106. In some preferred embodiments, the structured document includes metadata (e.g., title, source, description, asset type, etc.) associated with each media asset.

In some embodiments the structured document 308 includes only the metadata for one or more media assets, such as the metadata associated with an image asset, while the media asset, such as a file storing image content, may be stored as a separate resource. Alternatively or additionally, the structured document 308 can include the metadata associated with a media asset and can include the media asset itself (e.g., the structured document 308 can include the text content of a text-based media asset).

FIG. 3 also illustrates an example of an archive interface 310. In some embodiments, the archive interface 310 enables a user to interact with the archive server 110. For example, in some embodiments the user interacts with interface elements of the archive interface 310 to archive media assets associated with the structured document 308. In FIG. 3, the archive interface 310 is illustrated as a structured document displayed within the structured document display area 306. For example, in one non-limiting embodiment, the archive interface 310 comprises another structured document (e.g., an HTML document) displayed in an HTML inline frame (i.e., “iframe”). In other embodiments, the archive interface 310 may be integrated with the user interface controls 304 (e.g., the archive interface 310 can be displayed in a user control area 302), or displayed in another area of the display interface 212 that is not within the user interface 300.

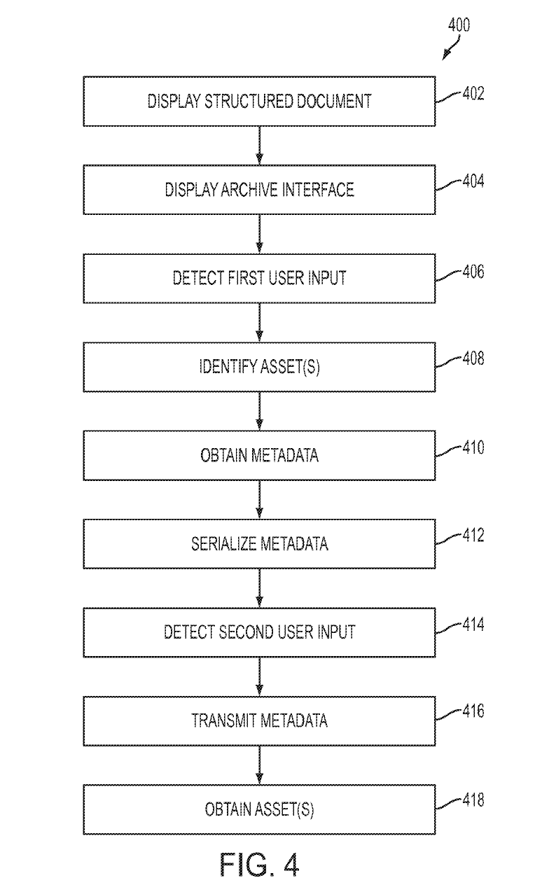

FIG. 4 is a flow chart illustrating a process 400 for archiving media assets according to some aspects of the present invention. In some embodiments, the process 400 is performed by a user terminal 102 executing software instructions (e.g., software instruction stored in the computer readable memory 206). In one non-limiting example, all or part of the process 400 is performed by a user terminal 102 executing web browser software. In another non-limiting example, process 400 is performed by a user terminal 102 executing instructions stored in a read only memory (“ROM”) or other firmware. In another non-limiting example, all or part of the process 400 is performed by the archive server 110.

The process 400 begins at step 402 by displaying a structured document 308 (e.g., by displaying a structured document 308 in the document display area 306 of a user interface 300).

At step 404, the process 400 displays an archive interface 310. In some embodiments, step 404 occurs automatically in response to displaying a structured document 308. In one non-limiting example, a web browser is configured to display the archive interface 310 whenever a web page is displayed. In other embodiments, step 404 occurs in response to a user input event (e.g., a user interacting with one or more user controls 304). In one non-limiting example, step 404 occurs in response to a user activating a JavaScript module (e.g., a bookmarklet). In another example, the step 404 may occur before the step 402, that is, the archive interface 310 can be displayed before the structured document is displayed.

In some embodiments, some or all of the executable instructions for displaying the archive interface 310 are stored on a remote computer (e.g., a remote server 106 or the archive server 110). In these embodiments, the step 404 can include one or more requests (e.g., from a user terminal 102) to one or more remote computers for resources including computer executable instructions for displaying the archive interface 310. For example, in one non-limiting embodiment, the step 404 can include requesting one or more HTML files and JavaScript source files from the archive server 110.

At step 406, the process 400 detects a user input event associated with the structured document 308. In one non-limiting example, the step 406 includes detecting a drag start event (e.g., a JavaScript “dragstart” event) from one or more elements associated with the structured document 308 (e.g., detecting when a user selects and begins to drag an image from the structured document 308). In another non-limiting example, the step 406 can include detecting that a user has highlighted, selected, or otherwise specified a portion of text associated with the structured document 308.

At step 408, the process 400 identifies one or more media assets based on the user event detected at step 406. For example, in some embodiments the step 408 includes determining which HTML elements in the structured document 308 are related to a detected dragstart event. In some embodiments, this can further include examining one or more predefined data objects related to the input event (e.g., a JavaScript “dataTransfer” object or “target” object associated with the input event).

At step 410, the process 400 obtains metadata associated with the media assets identified in step 408. This can include, by way of example, obtaining the metadata via the archive interface 310, or obtaining the metadata via other executable instructions, such as JavaScript instructions, that are associated with the structured document 310. In another example, the step 410 can include transferring the metadata from the structured document 308 to the archive interface 310. In some embodiments, the step 410 can further include examining one or more predefined data objects related to the input event (e.g., a JavaScript dataTransfer object or target object associated with the input event).

In some embodiments, the metadata can include HTML properties of HTML elements identified in step 408. In some embodiments, the metadata also includes metadata associated with the structured document 308, such as the title of the structured document 308, the source of the structured document 308. In a preferred embodiment, the metadata includes source-identifying information (e.g., a URL) for each identified media asset.

In some embodiments, transferring data between the structured document 308 and the archive interface 310 may be limited. For example, in some embodiments, the structured document 308 is a first HTML page, and the archive interface 310 is a second HTML page. In these embodiments, transferring data between the structured document 308 and the archive interface 310 can be limited by web browser security policies (e.g., the “same origin policy”). To ensure that the metadata associated with the identified media assets will be accurately received by the archive interface, in some embodiments a step 412 includes serializing the metadata. For example, in some embodiments the metadata can be serialized using JavaScript Object Notation (“JSON”), Base64 encoding, Base85 encoding, or any other suitable serialization method that will be readily understood by those having skill in the art, to generate a text string or other serialized data that can be reliably transferred between the structured document 308 and the archive interface 310.

At step 414, the process 400 detects a second user input event. For example, in some preferred embodiments, step 414 comprises detecting the end of a drag operation by the user (e.g., detecting a JavaScript “drop” event). In some embodiments, the second user input event is associated with the archive interface 310 (e.g., detecting a “drop” event where a user dragged one or more media assets from the structured document 308 into the display area of the archive interface 310).

In response to detecting the second user input event, at step 416 the process 400 transmits the metadata to a remote server (e.g., archive server 110). In some embodiments, the step 416 can include deserializing the metadata from a serialized data source (e.g., deserializing a text string generated at step 412).

In some embodiments, the first and second input events may be a single input event (that is, steps 408, 410, 412, and 416 may occur in response to the same user input event). For example, in one non-limiting embodiment, the steps 408, 410,412, and 416 all occur in response to a user clicking on a control element in the structured document 308 or in the archive interface 310.

In some preferred embodiments, the metadata transmitted to the archive server 110 includes a title associated with the structured document 308, a source identifying information (e.g., a URL) associated with the structured document 308, and a privacy setting. The privacy setting can be used to indicate, for example, whether the user wants the media asset to be made available to others from the archive server. In one non-limiting embodiment, the available privacy settings include: public (all other users can view the media asset and the asset is publicly indexed), private (only the user that archived the media asset can view the asset and the asset is not indexed), and secret (the media asset is not indexed, but any other user can view the asset if the archiving user provides the other user with the asset's location within the archive (such as by providing a unique token or URL associated with the archived asset that is difficult for another user to guess).

In some preferred embodiments, step 416 further includes classifying the one or more identified media assets by one or more predetermined media asset types (e.g., image, text, video, audio, etc.). In these embodiments, the process 400 configures the metadata transmitted to the remote server (e.g., the archive server 110) based on the types of identified media assets. In one non-limiting example, if the media asset is of type “text,” step 416 can include configuring the metadata to include the text content of the asset itself. In another example, if the media asset is of type “URL,” step 416 can include configuring the metadata to include the URL itself. In another example, if the asset is of type “image” or another format containing raw binary data (e.g., non-ASCII data), step 416 can include configuring the metadata to include a URL indicating the location at which the asset can be accessed (e.g., a URL for the asset).

At step 418, the remote server (e.g., the archive server 110) uses the metadata provided by the user terminal 102 to obtain the one or more identified media assets (e.g., obtain data comprising the media assets from another server indicated by a URL in the metadata) and archive those assets. In some embodiments, the step 418 includes storing the obtained media assets in a data store (e.g., on a magnetic hard drive, in a flash memory device, in an optical storage device, or using any other suitable electronic or digital storage means as will be understood by those having skill in the art), and storing the metadata in association with the corresponding media assets. In some embodiments, the step 418 can also include indexing the stored media assets, e.g., based on the associated metadata. In one non-limiting example, the step 418 includes the archive server receiving the metadata associated with one or more media assets, using the metadata do determine the source of the assets, obtaining the assets, storing the assets on a magnetic hard drive, and indexing the stored assets based on the received metadata.

The preceding description of the process 400 is by way of example only. In some alternative embodiments, one or more of the steps described with reference to the process 400 can be altered, omitted, or rearranged. For example, in some preferred embodiments, the step 404 (i.e., displaying the archive interface 310) can occur after one or more of the subsequently described steps 406 through 418. For example, in some embodiments the archive interface 310 can be displayed after or in response to one or more user input events identifying media assets. Other modifications to the process 400 that are within the scope of the present invention will be readily understood by those having skill in the art in view of the present disclosure.

Web browsers are often designed to incorporate additional software modules (e.g., plug-ins) for handling various types of external media assets (e.g., Adobe® Flash® assets). In some embodiments, the interface between a plug-in and the web browser prevents the browser from detecting user input events associated with the external asset. For example, when a user is interacting with an Adobe® Flash® asset associated with a web page, the Adobe® Flash® application typically receives all of the user input events, rather than the web browser.

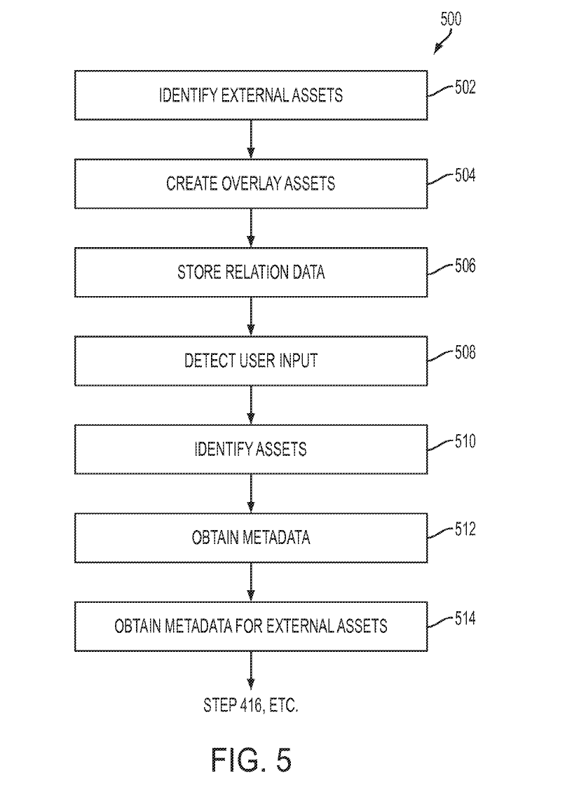

FIG. 5 is a flow chart illustrating a process 500 for archiving external media assets (i.e., media assets that are displayed using a plug-in) according to some aspects of the present invention. In some embodiments, the process 500 is performed by a user terminal 102 executing software instructions (e.g., software instructions stored on the computer readable memory 206). In one non-limiting example, all or part of the process 500 is performed by a user terminal 102 executing web browser software. In another non-limiting example, process 500 is performed by a user terminal 102 executing instructions stored in a read only memory (“ROM”) or other firmware. In another non-limiting example, all or part of the process 500 is performed by the archive server 110. In some preferred embodiments, the process 500 is performed in concert with the process 400, as further explained hereinafter.

The process 500 begins at step 502 when the process identifies an external media asset associated with a structured document (e.g., structured document 308). In some embodiments, a web browser may be configured to automatically process a structured document (e.g., a web page) and identify external media assets based on predetermined criteria. In one non-limiting example, the predetermined criteria can include the presence of predetermined HTML tags (e.g., “object” or “embed” tags) or other characteristics that those of skill in the art will readily understand as typically signifying that a media asset will be displayed using a plug-in.

At step 504, the process 500 creates a new overlay asset for each of the external media assets that were identified in step 502. In preferred embodiments, the overlay asset is an asset type that can be displayed without a plug-in and user input events associated with the overlay asset will be received, e.g., by the web browser. Furthermore, it is preferable that the overlay asset is displayed with the structured document (e.g., the structured document 308) so that a user can visually associate the overlay asset with the corresponding external media asset. In one non-limiting example, the overlay asset comprises a semi-transparent image that is displayed in the same display region as the external media asset. In another non-limiting example, the overlay asset comprises a frame image that is displayed around the display region of the external media asset.

At step 506, the process 500 stores relation data indicating a relationship between each overlay asset and its corresponding external media asset. In one non-limiting example, the relation data comprises an entry in a look up table, e.g., a table of one or more {overlay asset, external media asset} pairs. Preferably, the look up table is indexed based on the overlay asset, so that when the overlay indicated by a user input event, the corresponding external media asset can be easily identified.

In another non-limiting example, the relation data comprises metadata associated with the overlay asset. In some embodiments, the relation data includes a function that will execute when the web browser detects a user input event associated with the overlay asset. For example, in some embodiments the HTML “ondragstart” property of the overlay asset can be used to store a JavaScript function that will provide metadata for the related external media asset when a JavaScript “dragstart” event is generated for the overlay asset.

At step 508, the process 500 detects a user input event (e.g., a dragstart event) associated with the structured document 308, as described with reference to step 406 of the process 400.

At step 510, the process 500 identifies one or more media assets based on the user events, as described with reference to step 408 of the process 400.

At step 512, the process 500 obtains metadata associated with the assets identified in step 510, as described with reference to step 410 of the process. 400.

In some embodiments, at step 514 the process 500 includes using the relation data stored in step 506 to obtain metadata associated with an external media asset that corresponds to an overlay asset. For example, in some embodiments, step 514 comprises determining whether any of the identified assets are overlay assets. In one non-limiting example, this can include comparing one or more attributes of the identified assets with one or more predetermined values. In the case that any of the identified assets is an overlay asset, the step 514 can also include using a look up table to identity the corresponding external media asset and obtaining metadata associated with that external media asset.

In some embodiments, step 514 includes obtaining metadata associated with an external media asset from the metadata associated with the corresponding overlay asset. In one non-limiting example, this can include executing a function stored in the metadata associated with the overlay asset that will provide the metadata associated with the external asset (e.g., executing a JavaScript function that was associated with the “ondragstart” property of the overlay asset in step 506 to provide metadata associated with the external media asset).

The process 500 may then proceed as described with regard to steps 412 through 416 of the process 400. In some embodiments, if the asset is an external media asset, the step 416 includes transmitting a serialized metadata string (e.g., a JSON string containing metadata associated with the media asset) to the remote server.

It can occur that a user wishes to archive media assets that are only indirectly associated with a structured document. For example, a structured document (e.g., a web page) may include a low-resolution version of an image (i.e., a “thumbnail”), but the user wishes to archive a higher resolution version of the image. The higher resolution version of the image may be available as a media asset on the remote server 106, but may be associated with a different web page (e.g., a website may include a thumbnails page and an individual web page for each high resolution image). In some aspects, the present invention includes processing the structured document and identifying additional media assets that are indirectly associated with the structured document, and presenting the additional media assets to the user for optional archiving.

In one non-limiting example, this can include transmitting to a remote server (e.g., archive server 110 or another remote server) metadata associated with the structured document (e.g., the URL of a web page). In some embodiments, the metadata associated with the structured document is only transmitted if it satisfies one or more predetermined criteria (e.g., the URL is only transmitted if it satisfies a predetermined URL pattern filter).

In response, the remote server provides metadata associated with additional media assets that are not directly associated with the structured document but may be of interest to the user. This can include, at the remote server, utilizing one or more application programming interfaces (APIs) for the service (e.g., a website) that is providing the structured document, processing the document to identify hyperlinks or other indications of related content, or other predetermined methods for identifying indirectly associated media assets. The indirectly associated media assets can be displayed with the structured document 308 or within the archive interface 310, and the user can archive these additional assets as described with reference to the processes 400 and 500.

Occasionally, security policies or other technological or logistical limitations may prevent the archive server 110 from successfully archiving the media assets selected by the user. For example, the structured document 308 can be a website in one security domain that requires authentication credentials that are not available to an archive interface 310 or an archive server 110 that is outside of the security domain.

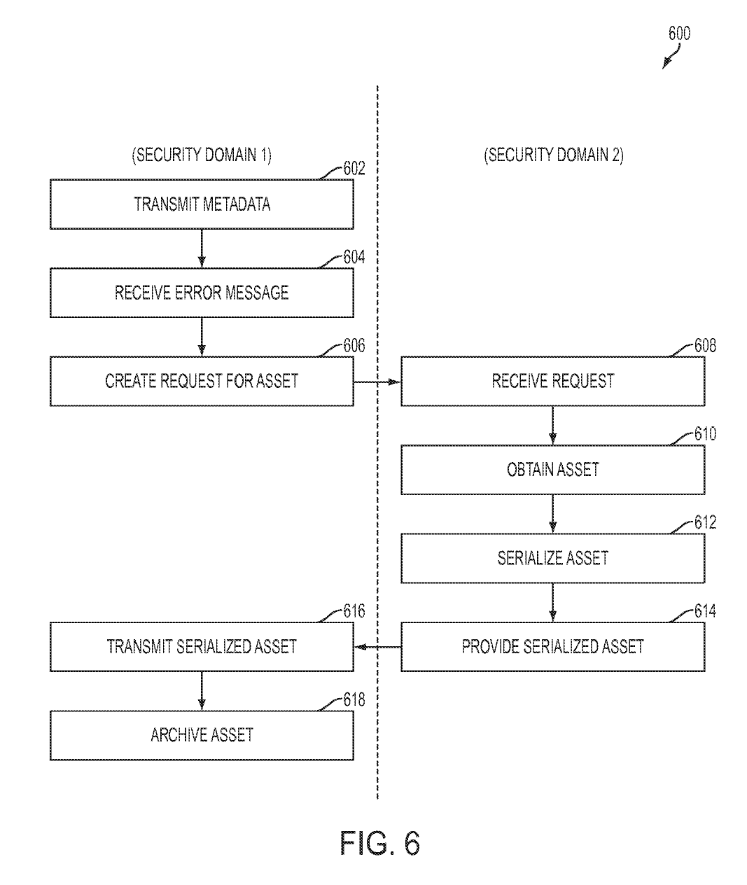

FIG. 6 is a flow chart illustrating a process 600 for archiving media assets between different security domains according to some aspects of the present invention. In some embodiments, the process 600 is performed by a user terminal 102 executing software instructions (e.g., software instructions stored in the computer readable memory 206). In one non-limiting example, all or part of the process 600 is performed by a user terminal 102 executing web browser software. In another non-limiting example, process 600 is performed by a user terminal 102 executing instructions stored in a read only memory (“ROM”) or other firmware. In another non-limiting example, all or part of the process 600 is performed by the archive server 110. In some preferred embodiments, the process 600 is performed in concert with the process 400.

The process 600 begins at step 602 when the user terminal transmits the metadata associated with one or more media assets to a remote server (e.g., archive server 110), as described with reference to step 416 of the process 400. In some preferred embodiments, the metadata may be transmitted by the archive interface 310. In some embodiments (e.g., in embodiments where the archive interface 310 is a web page displayed in an iframe), one or more of the archive interface 310 and the archive server 110 may be in a security domain that is separate from the security domain of the structured document 308 and one or more of the media assets.

At step 604, the user terminal 102 receives an indication from the archive server 110, indicating that the archive server 110 was unable to archive one or more of the identified media assets (e.g., via an error message), possibly because the archive server 110 is in a different security domain than the structured document 308 and is not authorized to access media assets associated with the structured document 308. In some preferred embodiments, the indication is received by the archive interface 310.

In response to receiving the indication that the archive server 110 was unable to archive a media asset, at step 606 the user terminal creates a request to obtain the media asset (e.g., via the archive interface 310) and transmits said request to the security domain of the structured document 308. In some embodiments, this can include the archive interface 310 generating a JavaScript message and sending that message to the structured document 308 (e.g., by using the window.postMessage method).

At step 608, a request handler that is associated with the structured document 308 and that is in the same security domain as the structured document 308 receives the request to obtain the media asset. In some embodiments, the request handler is included in a JavaScript bookmarklet that is loaded into the same security domain as the structured document 308 by a web browser executing on the user terminal 102.

In response to receiving the request, at step 610 the request handler obtains the media asset (i.e., obtains data comprising the asset) from a remote server (e.g., remote server 106). In preferred embodiments, the media asset is in the same security domain as the structured document 308 and the request handler, which preferably is also in the same security domain as the structured document 308, is authorized to obtain the media asset.

In one non-limiting embodiment, the step 610 includes creating a data container (e.g., an HTML document node) in the structured document 308 and associating the media asset data with the data container. For example, in a case where the asset is an image, the step 610 can include creating a new image or “img” node in the structured document 308 and setting the “src” attribute of the image node to the URL of the image asset. As will be readily understood by those having skill in the art, this will typically cause web browser software to download the image data from the URL and associate the downloaded data with the image node.

As described above, in some embodiments, transferring data between the security domain of the structured document 308 and the security domain of the archive interface 310 may be limited. Therefore, in some embodiments, at step 612, the request handler serializes the asset. In one non-limiting embodiment, the step 612 includes creating a second data container, transcribing the contents of the first data container to the second data container, and serializing the contents of the second data container. For example, in a case where the media asset is an image asset, the step 610 can include creating a new image node and associating the image asset data with the image node, as previously described with reference to step 610. Subsequently, the step 612 can include creating an HTML canvas node, drawing the contents of the image node to the canvas node, and Base64 encoding the contents of the canvas node (e.g., using the JavaScript “toDataURL” method of the canvas node).

At step 614, the handler provides the serialized media asset to the archive interface 310. In some embodiments, this can include the handler generating a JavaScript message and sending that message to the archive interface 310 (e.g., by using the window.postMessage method).

At step 616, the archive interface transmits the media asset to the archive server 110. In one preferred embodiment, this can include transmitting the serialized media asset to the archive server 110.

At step 618, the archive server 110 archives the media asset, for example as described with reference to the step 418 of the process 400. In some embodiments, the step 618 can include deserializing the media asset data (e.g., deserializing the serialized data created in step 612 to recover the media asset therefrom).

While various embodiments of the present invention have been described above, it should be understood that they have been presented by way of example only, and not limitation. Thus, the breadth and scope of the present invention should not be limited by any of the above-described exemplary embodiments. Moreover, any combination of the above described elements in all possible variations thereof is encompassed by the invention unless indicated herein or otherwise clearly contradicted by context.

We claim:

1. A method for archiving a media asset, comprising:
(a) transmitting from a first security domain to a remote server metadata associated with said media asset;
(b) receiving at said first security domain from said remote server an indication that said remote server did not archive said media asset;
(c) transmitting a request from said first security domain to a second security domain;
(d) in response to receiving said request at said second security domain, obtaining said media asset at said second security domain;
(e) at said second security domain, serializing said media asset;
(f) transmitting said serialized media asset from said second security domain to said first security domain; and
(g) transmitting said serialized media asset from said first security domain to said remote server.

2. The method of claim 1 wherein said first security domain is associated with a server providing an archive interface, and said second security domain is associated with a server providing a website including said media asset.

3. The method of claim 2, further comprising:
(h) simultaneously displaying said archive interface and said website.

4. The method of claim 1, wherein said metadata comprises a Uniform Resource Identifier (URI) indicating the source of said media asset.

5. The method of claim 1, wherein step (e) further comprises:
(i) creating a first data container,
(ii) storing said media asset in said first data container,
(iii) creating a second data container,
(iv) transcribing the contents of said first data container into said second data container, and
(v) serializing the contents of said second data container.
